(19) United States
(12) Patent Application Publication
(10) Pub. No.: US 2026/0153830 A1
(43) Pub. Date: Jun. 4, 2026

(54) IMAGE FORMING APPARATUS

(71) Applicant: CANON KABUSHIKI KAISHA, Tokyo (JP)

(72) Inventors: KENSUKE UMEDA, Kanagawa (JP); TOSHIHIKO TAKAYAMA, Kanagawa (JP); SHINSUKE KOBAYASHI, Kanagawa (JP)

(21) Appl. No.: 19/457,351

(22) Filed: Jan. 23, 2026

Related U.S. Application Data
(63) Continuation of application No. PCT/JP2024/017905, filed on May 15, 2024.

(30) Foreign Application Priority Data
Jul. 25, 2023 (JP) 2023-121046

(51) Int. Cl. G03G 21/00; G03G 15/00

(52) U.S. Cl. CPC G03G 21/0047; G03G 15/5004; G03G 15/5008; G03G 21/0035; G03G 2221/0042; G03G 2221/0073

(57) ABSTRACT

The control unit of an image forming apparatus is configured to execute a first activation control for starting rotation of the photosensitive drum when a potential difference between the brush and the surface of the photosensitive drum is a first potential difference and a second activation control for starting rotation of the photosensitive drum when the potential difference between the brush and the surface of the photosensitive drum is a second potential difference. Each of the first potential difference and the second potential difference is formed such that an electrostatic force from the brush toward the surface of the photosensitive drum acts on a particle charged to a polarity opposite to the normal polarity of the toner. An absolute value of the second potential difference is greater than that of the first potential difference.

### CROSS-REFERENCE TO RELATED APPLICATIONS

This application is a Continuation of International Patent Application No. PCT/JP2024/017905, filed May 15, 2024, which claims the benefit of Japanese Patent Application No. 2023-121046, filed Jul. 25, 2023, both of which are hereby incorporated by reference herein in their entirety.

### BACKGROUND

### Field of the Technology

The present disclosure relates to an image forming apparatus of electrophotographic type.

### Description of the Related Art

Some electrophotographic image forming apparatuses are of the cleanerless type, in which toner remaining on a surface of a photosensitive drum after a transfer step is removed and collected by a developing unit and then reused. The cleanerless type image forming apparatus is not provided with a conventional blade that scrapes residual toner off the surface of the photosensitive drum, and as a result, paper dust that adheres to the surface of the photosensitive drum during the transfer step cannot be removed, potentially resulting in image defects. Japanese Patent Application Publication No. 2007-65580 proposes a configuration in which a fixed brush is disposed at a position downstream of a transfer portion and upstream of a charging portion in a rotational direction of the photosensitive drum, so that paper dust adhering to the drum surface is removed by a fixed brush.

When the brush is brought into contact with the photosensitive drum, paper dust collected and held in the brush may pass to the downstream side of the brush due to speed fluctuations as the rotation driving of the photosensitive drum is started. In this case, the paper dust that has passed to the downstream side may adhere to a charging member, thereby causing image defects, for example.

### SUMMARY

The present disclosure serves to suppress image defects in an image forming apparatus including a brush configured to contact with the surface of a photosensitive drum.

According to one aspect of the present disclosure, an image forming apparatus includes: a photosensitive drum that is rotatable; a charging unit configured to form a charging portion between the photosensitive drum and the charging unit and charge a surface of the photosensitive drum in the charging portion; a developing unit configured to contact with the photosensitive drum to form a developing portion and supply, in the developing portion, toner to the surface of the photosensitive drum charged by the charging unit; a transfer unit configured to contact with the photosensitive drum to form a transfer portion and transfer, in the transfer portion, the toner supplied to the photosensitive drum to a transfer target; a brush configured to contact with the surface of the photosensitive drum downstream of the transfer portion and upstream of the charging portion in a rotational direction of the photosensitive drum; an applying unit configured to apply a voltage to the brush; a drive unit configured to rotate the photosensitive drum; and a control unit configured to control the applying unit and the drive unit. The control unit is configured to execute a first activation control and a second activation control. The first activation control starts the rotation of the photosensitive drum in a state in which a potential difference between the voltage applied to the brush and a potential of the surface of the photosensitive drum is a first potential difference. The second activation control starts the rotation of the photosensitive drum in a state in which the potential difference between the voltage applied to the brush and the potential of the surface of the photosensitive drum is a second potential difference. Each of the first potential difference and the second potential difference is formed such that an electrostatic force from the brush toward the surface of the photosensitive drum acts on a particle charged to a polarity opposite to a normal polarity of the toner. The second potential difference has an absolute value greater than an absolute value of the first potential difference.

Features of the present disclosure will become apparent from the following description of embodiments with reference to the attached drawings.

### BRIEF DESCRIPTION OF THE DRAWINGS

FIG. 1 is a schematic view of the configuration of an image forming apparatus according to a first embodiment.

FIG. 2A is a schematic view of a brush member according to the first embodiment. FIG. 2B is a schematic view of the brush member in contact with a photosensitive drum 1.

FIG. 3 is a control block diagram according to the first embodiment.

FIGS. 4A and 4B are schematic views illustrating the process of paper dust collection by the brush member according to the first embodiment.

FIGS. 5A and 5B are schematic views illustrating changes in the posture of the brush member according to the first embodiment.

FIGS. 6A and 6B are schematic views illustrating the process of expelling paper dust from the brush member.

FIG. 7 is a schematic view of a black spot image on a recording material.

FIG. 8 is a flowchart for illustrating a second activation control and a paper dust collection sequence according to the first embodiment.

FIGS. 9A, 9B, and 9C are schematic views illustrating the process of the second activation control and a paper dust collection sequence according to the first embodiment.

FIG. 10 is a table which gives test results according to the first embodiment.

FIG. 11 is a table which gives test results according to a second embodiment.

### DESCRIPTION OF THE EMBODIMENTS

Referring to the drawings, modes for carrying out the present disclosure will be described in detail by way of illustration on the basis of embodiments. However, dimensions, materials, shapes, relative positioning, voltages, speeds, densities, and other characteristics of components described in the embodiments are merely examples for the purpose of description, and may be modified as appropriate in accordance with the configuration of the apparatus to which the present disclosure is applied and various conditions. In particular, the technical scope of the present disclosure is not limited by the following embodiments.

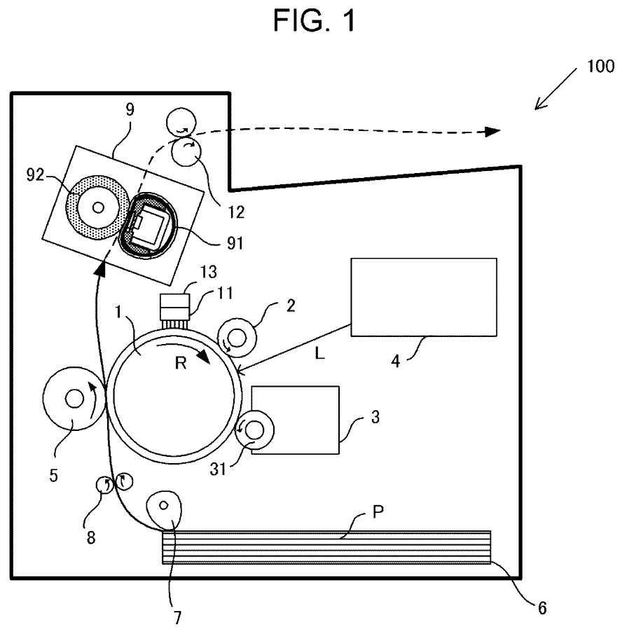

### First Embodiment

<1. Image Forming Apparatus> FIG. 1 is a schematic view of the configuration of an image forming apparatus 100 according to the first embodiment. The image forming apparatus 100 is a monochromatic laser beam printer based on a cleanerless system and a contact charging system. The image forming apparatus 100 is provided with a rotatable cylindrical photosensitive drum 1 serving as an image bearing member. A charging roller 2 as a charging unit and a developing apparatus 3 as a developing unit are provided around the photosensitive drum 1. Further, as shown in FIG. 1, an exposure unit 4 is provided between the charging roller 2 and the developing apparatus 3 in the rotational direction of the photosensitive drum 1. A transfer roller 5 as a transfer unit is pressed against the photosensitive drum 1.

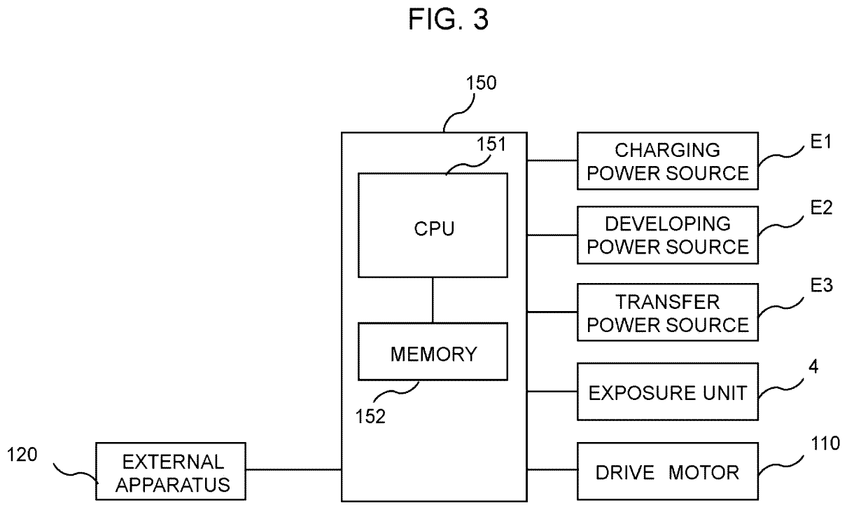

The photosensitive drum 1 is a negatively chargeable organic photosensitive member. The photosensitive drum 1 has a photosensitive layer on a drum-shaped aluminum base, and is driven to rotate in the direction of the arrow R (clockwise direction) at a prescribed process speed by a drive motor 110 (FIG. 3) serving as a drive unit. In the first embodiment, the photosensitive drum 1 has an outer diameter of 24 mm, and the process speed (peripheral velocity (surface movement speed) of the photosensitive drum 1) is 140 mm/sec.

The charging roller 2 is in contact with the photosensitive drum 1 under a prescribed pressing force, forming a charging portion between the photosensitive drum 1 and itself and charges the surface of the photosensitive drum 1. During the charging process, a prescribed charging voltage (charging bias) is applied to the charging roller 2 from a charging power source E1 (FIG. 3) serving as a charging-voltage applying unit, so that the surface of the photosensitive drum 1 is uniformly charged to a prescribed potential. During the charging process, a negative-polarity DC voltage is applied to the charging roller 2 as the charging voltage, and the surface of the photosensitive drum 1 is uniformly charged by the charging roller 2 to a negative-polarity dark potential Vd. In the first embodiment, the charging voltage is −1300 V, and the dark potential Vd of the photosensitive drum 1 is −700 V.

More specifically, the surface of the photosensitive drum 1 is charged by discharge occurring in at least one of the minute gaps between the photosensitive drum 1 and the charging roller 2 formed upstream and downstream of the contact portion between the photosensitive drum 1 and the charging roller 2 with respect to the rotational direction of the photosensitive drum 1. In the following description, the contact portion between the charging roller 2 and the photosensitive drum 1 with respect to the rotational direction of the photosensitive drum 1 is regarded as the charging portion.

The exposure unit 4 is a laser scanner that outputs a laser beam L corresponding to image information input from an external apparatus 120 (FIG. 3) such as a host computer and performs scanning exposure on the surface of the photosensitive drum 1. By this exposure, an electrostatic latent image (electrostatic image) corresponding to the image information is formed on the surface of the photosensitive drum 1. The dark potential Vd of the surface of the photosensitive drum 1 formed in a uniformly charged state by the charging process is decreased in absolute value by the exposure performed by the exposure unit 4 and becomes a light potential Vl. In the first embodiment, the light potential Vl is −100 V.

In the following description, the position on the surface of the photosensitive drum 1 that is exposed by the exposure unit 4 with respect to the rotational direction of the photosensitive drum 1 is regarded as an exposure portion (exposure position). The exposure unit 4 is not limited to a laser scanner, and may be an LED array having a plurality of LEDs arranged in the longitudinal direction of the photosensitive drum 1.

The image forming apparatus 100 adopts a contact developing method as a developing method. The developing apparatus 3 includes a developing roller 31 serving as a developer carrying member, a toner supply roller serving as a developer supply unit, a developer containing chamber for storing toner, and a developing blade. The toner supplied to the developing roller 31 from the developer containing chamber by the toner supplying roller is charged to a prescribed polarity while passing through a blade nip as the contact portion between the developing roller 31 and the developing blade. The toner carried on the developing roller 31 is supplied from the developing roller 31 to the surface of the photosensitive drum 1 in accordance with an electrostatic image in a developing portion.

In the following description, the contact portion between the developing roller 31 and the photosensitive drum 1 with respect to the rotational direction of the photosensitive drum 1 is regarded as the developing portion. The developing roller 31 is driven to rotate counterclockwise so that the developing roller 31 and the photosensitive drum 1 move in the same direction at the developing portion. The drive motor 110 (FIG. 3) serving as a drive unit for driving the developing roller 31 may be a common motor with the drive motor 110 serving as the drive unit for the photosensitive drum 1, or separate drive motors may respectively rotate the photosensitive drum 1 and the developing roller 31. During development, a prescribed developing voltage (developing bias) is applied to the developing roller 31 from a developing power source E2 (FIG. 3) serving as a developing-voltage applying unit. During development, a negative-polarity DC voltage is applied as the developing voltage to the developing roller 31. In the first embodiment, the developing voltage is −380 V.

On the surface of the photosensitive drum 1, an image forming portion (exposure surface, image portion) whose potential in absolute value has decreased due to exposure following uniform charging forms. Toner charged to the same polarity (negative polarity in the first embodiment) as the charging polarity of the photosensitive drum 1 adheres to the exposure surface. This developing method is referred to as a reversal developing method. In the first embodiment, the normal charging polarity of the toner during development is negative polarity.

For example, the present disclosure can be applied to a one-component nonmagnetic contact developing method, a two-component nonmagnetic contact developing method, a non-contact developing method, or a magnetic developing method. In the two-component nonmagnetic contact developing method, development is performed by bringing a developer (magnetic brush) carried on a developer carrying member into contact with the photosensitive drum 1 using a two-component developer containing nonmagnetic toner and magnetic carrier as the developer. In the non-contact developing method, development is performed by causing toner to fly to the photosensitive member from the developer carrying member disposed to face the photosensitive member in a non-contact manner with respect to the photosensitive member. In the magnetic developing method, development is performed by carrying magnetic toner by magnetic force on a developer carrying member disposed to face the photosensitive member in contact or in a non-contact manner and having therein a magnet serving as a magnetic-field generating unit. The toner of the first embodiment has a central average particle diameter of 6 μm and negative polarity as a normal charging polarity.

The transfer roller 5 serving as a transfer unit may preferably be an elastic member made of an elastic material such as sponge rubber formed of polyurethane rubber, EPDM (ethylene propylene diene rubber), or NBR (nitrile butadiene rubber). The transfer roller 5 is pressed against the photosensitive drum 1, and the photosensitive drum 1 and the transfer roller 5 are brought into contact with each other to form a transfer portion. During the transfer operation, a prescribed transfer voltage (transfer bias) is applied to the transfer roller 5 by a transfer power source E3 (FIG. 3) serving as a transfer-voltage applying unit. During the transfer operation, a DC voltage having an opposite polarity (which is positive polarity in the first embodiment) to the normal polarity of the toner is applied as the transfer voltage to the transfer roller 5. The toner image is electrostatically transferred from the photosensitive drum 1 to a recording material P serving as a transfer target by an electric field formed between the transfer roller 5 and the photosensitive drum 1. In the first embodiment, the transfer voltage is +1000 V.

The recording material P serving as a recording medium, which is stored in a cassette 6, is fed by a paper feeding unit 7 in synchronization with the timing at which the toner image formed on the photosensitive drum 1 reaches the transfer portion, and is conveyed through a registration roller pair 8 to the transfer portion. The toner image formed on the photosensitive drum 1 is transferred onto the recording material P by the transfer roller 5 to which a prescribed transfer voltage is applied by the transfer power source E3. The recording material P having the toner image transferred thereon is conveyed to a fixing unit 9. The fixing unit 9 is a film-heating-type fixing unit including a fixing film 91 with a built-in fixing heater (not shown) and a thermistor (not shown) for measuring the temperature of the fixing heater, and a pressure roller 92 to be pressed against the fixing film 91. The recording material P is heated and pressed so that the toner image is fixed thereto and then discharged to the outside of the apparatus through a discharge roller pair 12.

Transfer residual toner remaining on the photosensitive drum 1 without being transferred to the recording material P is removed in the following steps. The transfer residual toner includes toner charged to positive polarity and toner charged to negative polarity but having an insufficient charge amount. The transfer residual toner is again charged to the negative polarity by discharge at the charging portion in the charging roller 2. The transfer residual toner charged to the negative polarity again by the charging roller 2 reaches the developing portion as the photosensitive drum 1 rotates. At this point, an electrostatic latent image may or may not be formed on the surface of the photosensitive drum 1 that has reached the developing portion, thereby forming an image forming portion or a non-image forming portion, respectively. The behavior of the transfer residual toner that has reached the developing portion will be described separately for the image forming portion and the non-image forming portion of the photosensitive drum 1.

The transfer residual toner adhering to the image forming portion of the photosensitive drum 1 is not transferred from the photosensitive drum 1 to the developing roller 31 in the developing portion, but is moved to the transfer portion together with the developed toner from the developing roller 31, and is transferred to the recording material P for image formation. Meanwhile, the transfer residual toner adhering to the non-image forming portion of the photosensitive drum 1 is recharged to the negative polarity, which is the normal polarity, by the charging portion, and is transferred to the developing roller 31 by the potential difference between the non-image forming portion potential of the photosensitive drum 1 and the developing voltage in the developing portion, and is collected into the developer containing chamber. The toner collected in the developer containing chamber is used for image formation again.

As shown in FIG. 3, the image forming apparatus 100 transmits and receives image data and commands to and from the external apparatus 120, and includes a control unit 150 that controls operations of respective parts of the image forming apparatus 100. The control unit 150 includes a CPU 151 and a memory 152. The control unit 150 controls the operations of the charging power source E1, the developing power source E2, the transfer power source E3, the exposure unit 4, and the drive motor 110.

<2. Structure of Brush Member> Next, the paper dust removing member will be described. The image forming apparatus 100 includes a brush member 11 (contact member or collection member) serving as a paper dust removing member. The brush member 11 is brought into contact with the surface of the photosensitive drum 1 on the downstream side of the transfer portion and on the upstream side of the charging portion with respect to the rotational direction of the photosensitive drum 1, thereby forming a brush nip portion (brush contact portion or brush contact position). In the following description, the contact portion between the brush member 11 and the photosensitive drum 1 with respect to the rotational direction of the photosensitive drum 1 is regarded as the brush nip portion.

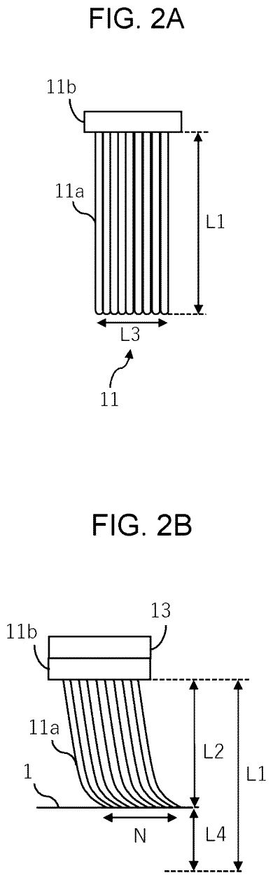

FIG. 2A is a schematic view of the brush member 11 alone as viewed in its longitudinal direction (substantially parallel to the rotational axis direction of the photosensitive drum 1). FIG. 2B is a schematic view of the brush member 11 in contact with the photosensitive drum 1 as viewed in its longitudinal direction.

The brush member 11 is a conductive brush fixed to the image forming apparatus 100. As shown in FIG. 2B, the brush member 11 includes conductive pile yarns 11a made of 6-nylon composed of a plurality of fibrous elements for rubbing the surface of the photosensitive drum 1 and a base cloth 11b supporting the pile yarns 11a. The brush member 11 is arranged to be in contact with the photosensitive drum 1 on the downstream side of the transfer portion and on the upstream side of the charging portion with respect to the moving direction (rotational direction) of the photosensitive drum 1. The brush member 11 is arranged such that its longitudinal direction is substantially parallel to the rotational axis direction of the photosensitive drum 1. The material of the pile yarns 11a may be of a material such as rayon, acrylic, or polyester in addition to nylon.

As shown in FIG. 2A, when the brush member 11 is alone, that is, when no external force acts to bend the pile yarns 11a, the length of the pile yarns 11a extending from the base cloth 11b is defined as L1. The base cloth 11b is fixed to a support member 13 provided at a prescribed position in the image forming apparatus 100 by a fixing unit such as double-sided adhesive tape. The position of the support member 13 and the length L1 of the pile yarns 11a are set such that the tips of the pile yarns 11a enter into the photosensitive drum 1 when the base cloth 11b is fixed to the support member 13. In the first embodiment, L1 is 6.5 mm.

The clearance between the support member 13 and the photosensitive drum 1 is constant. The shortest distance from the base cloth 11b of the brush member 11 fixed to the support member 13 to the photosensitive drum 1 is defined as L2. The intrusion amount L4 of the brush member 11 into the photosensitive drum 1 is defined as L4=L1−L2. In the first embodiment, L4 is 1 mm.

As shown in FIG. 2A, when the brush member 11 is alone, the length of the brush member 11 in the circumferential direction of the photosensitive drum 1 (hereinafter referred to as the “short direction”) is defined as L3. The length L3 of the brush member 11 in the short direction can be set according to the useful life of the image forming apparatus 100 or the process cartridge. As L3 increases, the brush member 11 can capture paper dust for a longer period, and L3 is preferably 3 mm or more from the viewpoint of supporting a long useful life. In the first embodiment, L3 is 5 mm.

The length of the brush member 11 in the longitudinal direction is set such that the brush member 11 comes into contact with the entire image forming region (where a toner image can be formed) on the photosensitive drum 1 with respect to the rotational axis direction of the photosensitive drum 1. The length of the brush member 11 in the longitudinal direction can be changed as appropriate according to the maximum sheet passage width of the image forming apparatus. In the first embodiment, the length of the brush member 11 in the longitudinal direction is 220 mm.

The density of the pile yarns 11a of the brush member 11 can be determined in consideration of toner passability and paper dust capturing performance. If the density of the brush member 11 is too high, toner passability deteriorates, and the toner may be stacked (agglomerated), and the stacked toner may scatter and cause contamination inside the apparatus. If the density of the brush member 11 is too low, the ability to capture paper dust is lowered. From the viewpoint of paper dust capturing performance, the pile yarns 11a preferably have a thickness of 1 to 6 denier and a density of 150 to 350 kF/inch². The unit “kF/inch²” indicates the number of filaments per square inch. In the first embodiment, the pile yarns 11a have a thickness of 2 denier and a density of 240 kF/inch².

The fineness of the brush member 11 can be determined in consideration of the passability of paper dust. If the fineness of the brush member 11 is too low, the ability to block paper dust decreases, and the paper dust is more likely to pass through. Therefore, the paper dust that has passed through may interfere with the charging of the photosensitive drum 1 by the charging roller 2. If the fineness of the brush member 11 is too high, toner and fine paper dust cannot be sufficiently captured. As a result, image defects such as density unevenness caused by uneven toner adhesion in the longitudinal direction of the charging roller 2, and image defects caused by charging failure in portions where paper dust adheres may occur. In the first embodiment, the fineness of the brush member 11 is 220T/96F. This means that 96 filaments are bundled together to form yarns having a weight of 220 g per 10,000 m.

The brush member 11 is supported by the support member 13 provided in the image forming apparatus 100 and is arranged at a fixed position with respect to the photosensitive drum 1 so as to rub the surface of the photosensitive drum 1 as the photosensitive drum 1 rotates. The brush member 11 captures (collects) adherents such as paper dust transferred from the recording material P to the photosensitive drum 1 in the transfer portion, and reduces the amount of paper dust that moves to the charging portion and the developing portion located downstream of the brush member 11 in the rotational direction of the photosensitive drum 1.

The contact portion between the brush member 11 and the photosensitive drum 1 will be referred to as a brush nip portion N. The brush member 11 is connected to a voltage applying unit that applies a voltage to the brush member 11. In the first embodiment, the voltage applying unit is common with the developing power source E2 (FIG. 3). That is, the developing power source E2 applies a voltage to both the developing roller 31 and the brush member 11. During image formation, a prescribed brush voltage (brush bias) is applied by the developing power source E2 to the brush member 11. During image formation, a DC voltage having negative polarity is applied as the brush voltage to the brush member 11. In the first embodiment, the brush voltage during image formation is −380 V.

<3. Image Output Operation> In the first embodiment, the image forming apparatus 100 performs an image forming operation (printing job) in response to an instruction from the external apparatus 120 such as a personal computer. A job is a series of operations for forming an image on one or more recording materials P and includes a pre-rotation step, an image forming step (printing step), an inter-sheet step for forming images on multiple recording materials P, and a post-rotation step.

The pre-rotation step corresponds to a period during which preparatory operations are performed before the image forming step.

The image forming step includes forming an electrostatic image on the photosensitive drum 1, developing the electrostatic image (forming a toner image), transferring the toner image, and fixing the toner image, and the term “during image formation” refers to a period during which the step is executed. Note that the formation of the electrostatic image, the formation of the toner image, the transfer of the toner image, and the fixing of the toner image are performed at different timings during image formation.

The inter-sheet step corresponds to the period between first and second recording materials P when the image forming step is continuously carried out on a plurality of recording materials P (during continuous image formation).

The post-rotation step corresponds to a period during which the arrangement operation (preparatory operation) is carried out after the image forming step.

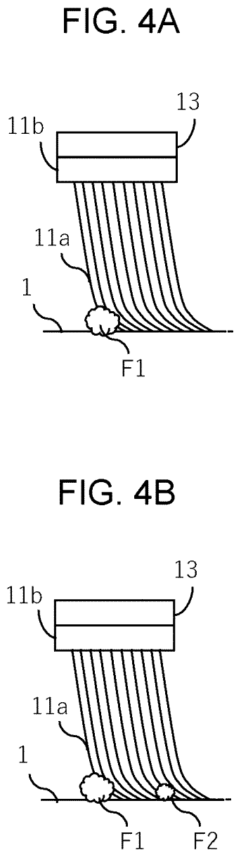

The term “non-image forming period” refers to a period other than the image forming period and includes the pre-rotation step, the inter-sheet step, the post-rotation step, and a pre-multi-rotation step, which is a preparatory operation performed when the power of the image forming apparatus 100 is turned on or when the apparatus resumes from a sleep state.

<4. Image Defects Caused by Paper Dust Expulsion> Paper dust from the recording material P adheres to the photosensitive drum 1 during transfer. The paper dust adhering to the photosensitive drum 1 is mainly charged to the same polarity as the transfer bias (the polarity opposite to that of the toner) by the transfer voltage. The paper dust on the photosensitive drum 1 is physically captured by the brush member 11 on the upstream side of the brush nip portion N. FIG. 4A shows a state in which paper dust F1 is captured on the upstream side of the brush nip portion N of the brush member 11.

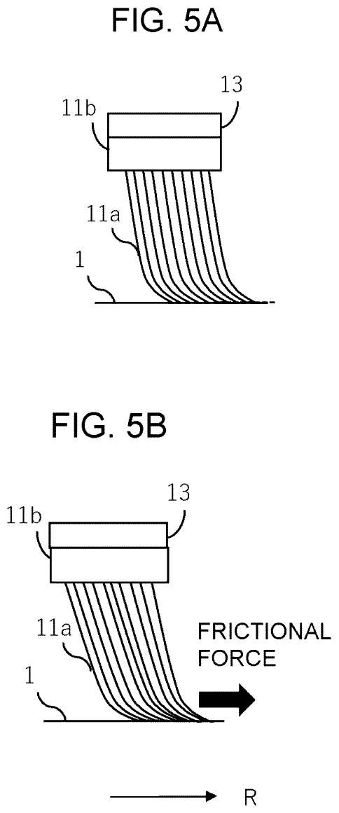

FIGS. 5A and 5B are views showing changes in the posture of the brush member 11. FIG. 5A shows the posture of the brush member 11 when the photosensitive drum 1 is stopped, and FIG. 5B shows the posture of the brush member 11 when the photosensitive drum 1 is rotating. The posture of the pile yarns 11a of the brush member 11 differs between when the photosensitive drum 1 is stopped and when it is rotating. This is because during the rotation of the photosensitive drum 1, the pile yarns 11a of the brush member 11 are pulled in the direction of rotation by the frictional force from the surface of the photosensitive drum 1.

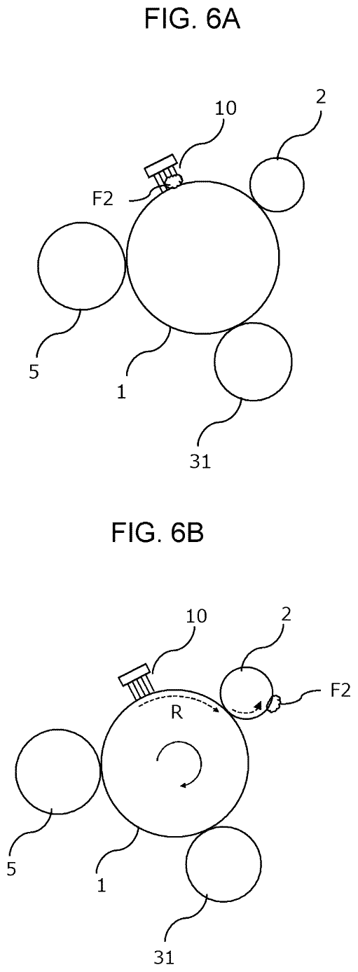

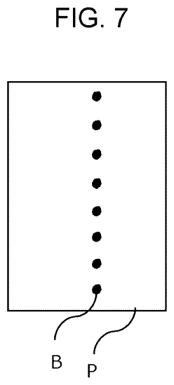

When the photosensitive drum 1 is activated and starts to rotate from a stopped state, the posture of the brush member 11 changes from the state shown in FIG. 5A to the state shown in FIG. 5B, so that the paper dust F1 located at the position shown in FIG. 4A may move to the downstream side in the rotational direction. Then, the paper dust F1 which has been at the position shown in FIG. 4A is moved to the position of the paper dust F2 shown in FIG. 4B. When the activation operation is repeatedly performed with paper dust accumulated on the brush member 11, the paper dust tends to move from the upstream side into the brush nip portion. The holding force on the paper dust F2 at the position shown in FIG. 4B is weak because only a small number of pile yarns 11a support the paper dust F2. Accordingly, as shown in FIGS. 6A and 6B, the paper dust F2 may be expelled from the brush member 11 during activation. In the state shown in FIG. 6A, the paper dust F2 is held inside the brush nip portion while the photosensitive drum 1 is stopped. FIG. 6B is a view showing the movement of the paper dust F2 when the activation operation of the photosensitive drum 1 is performed in the state shown in FIG. 6A. The paper dust F2 expelled from the brush member 11 may adhere to the charging roller 2 as shown in FIG. 6B. In this case, charging failure occurs, and black spots B may appear on the recording material P as shown in FIG. 7. When the paper dust F2 remains adhering to the charging roller 2 during rotation, the black spots B appear at intervals corresponding to the rotational period of the charging roller 2.

<5. Brush Paper Dust Expulsion Control> The brush paper dust expulsion control will be described. The control unit 150 of the image forming apparatus 100 can execute a first activation control and a second activation control as activation control for starting the rotation driving of the photosensitive drum 1. The first activation control starts the rotation driving of the photosensitive drum 1 in a state in which the potential difference between the brush member 11 and the surface of the photosensitive drum 1 is a first potential difference. The second activation control starts the rotation driving of the photosensitive drum 1 in a state in which the potential difference between the brush member 11 and the photosensitive drum 1 is a second potential difference. The first potential difference and the second potential difference are potential differences formed such that an electrostatic force acts from the brush member 11 toward the surface of the photosensitive drum 1 on particles (e.g., paper dust) charged with the opposite polarity to the normal polarity of the toner (the normal polarity being negative and the opposite polarity being positive in the first embodiment). In the first embodiment, the absolute value of the second potential difference is greater than that of the first potential difference.

Specifically, the surface potentials of the photosensitive drum 1 in the first activation control and the second activation control are equal to each other, and are both 0 V. The first brush voltage applied to the brush member 11 in the first activation control and the second brush voltage applied to the brush member 11 in the second activation control are both voltages having a polarity opposite (positive polarity) to the normal polarity (negative polarity) of the toner. The absolute value of the second brush voltage is greater than that of the first brush voltage. In the first embodiment, the first brush voltage is 150 V, and the second brush voltage is 450 V. That is, the second brush voltage during the second activation control is higher toward the polarity opposite to the normal polarity of the toner than the first brush voltage during the first activation control. In the first embodiment, since the power source for applying a voltage to the brush member 11 is common with the power source for applying a voltage to the developing roller 31, the voltage applied to the developing roller 31 is 150 V during the first activation control and 450 V during the second activation control.

The first activation control is executed in the pre-rotation step before the image forming operation. Accordingly, the photosensitive drum 1, whose rotation driving is started by the first activation control, enters the image forming step without stopping its rotation. Meanwhile, the second activation control is executed in the post-rotation operation, and the rotation driving of the photosensitive drum 1 started by the second activation control is stopped after the completion of the second activation control.

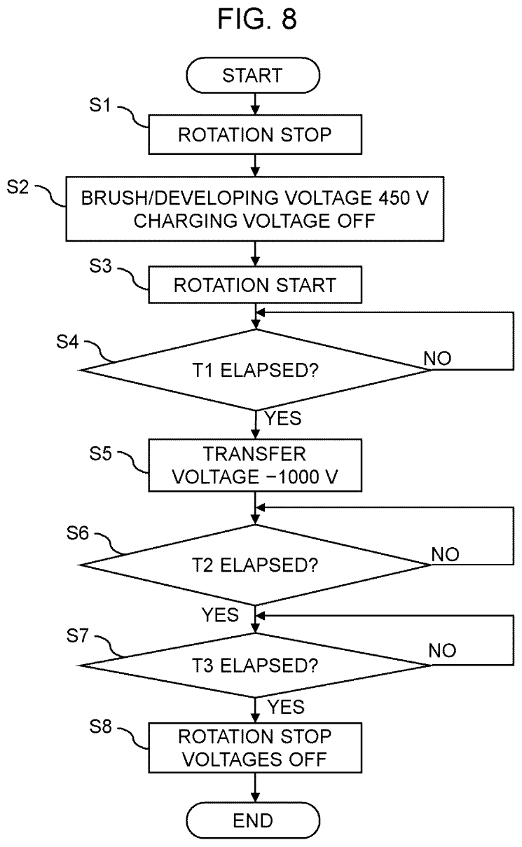

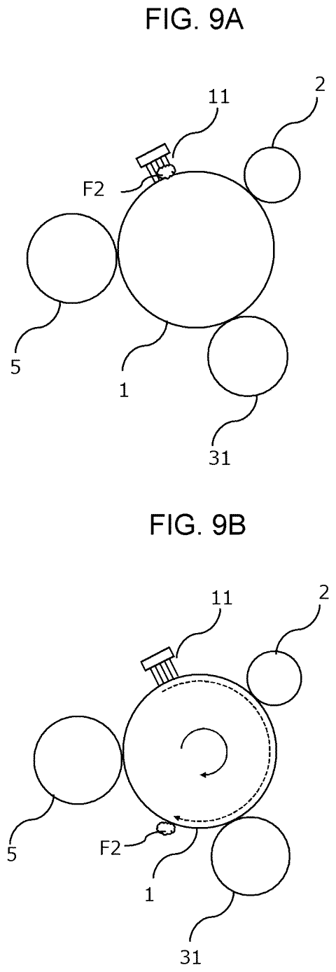

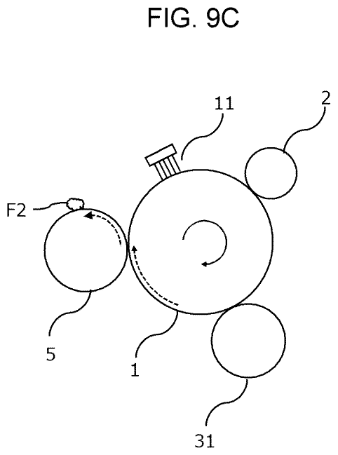

FIG. 8 is a flowchart for illustrating the sequence of the second activation control. FIGS. 9A, 9B, and 9C are schematic views illustrating the behavior of paper dust captured by the brush member 11 when the second activation control is executed.

When the second activation control is started, in step S1, the control unit 150 stops the rotation driving of the photosensitive drum 1 (FIG. 9A).

In step S2, the control unit 150 sets the voltages applied to the brush member 11 and the developing roller 31 to the second brush voltage 450 V, and turns off the voltage (0 V) applied to the charging roller 2. At the time, since no charging bias is applied, the surface potential of the photosensitive drum 1 does not change.

In step S3, the control unit 150 starts (activates) the rotation driving of the photosensitive drum 1. Due to the change in the posture of the brush member 11 caused by the activation and the second potential difference (450 V) between the brush member 11 and the surface of the photosensitive drum 1, the positively charged paper dust F2 that has been captured in the brush nip portion N is expelled.

In step S4, the control unit 150 determines whether a period T1 corresponding to the distance between the brush portion and the developing portion has elapsed after the start of rotation of the photosensitive drum 1 in step S3. The period T1 corresponding to the distance between the brush portion and the developing portion refers to the time required for a position on the surface of the photosensitive drum 1 located at the brush portion at the start of the rotation of the photosensitive drum 1, to reach the developing portion. If the period T1 corresponding to the distance between the brush portion and the developing portion has not elapsed (NO in step S4), the control unit 150 returns to step S4. If the period T1 corresponding to the distance between the brush portion and the developing portion has elapsed (YES in step S4), the control unit 150 executes step S5. In this way, the positively charged paper dust F2 which has been expelled passes the charging roller 2 and the developing roller 31 (FIG. 9B). At the time, by applying 0 V or a positive voltage to the charging roller 2 and the developing roller 31, the expelled positively charged paper dust F2 can be prevented from actively adhering to the charging roller 2 and the developing roller 31. In the first embodiment, the voltage of the charging roller 2 is turned off (0 V) in step S2, and the voltage applied to the developing roller 31 is 450 V.

In step S5, the control unit 150 applies a voltage of −1000 V to the transfer roller 5. That is, after the start of rotation of the photosensitive drum 1, at a timing when the period corresponding to the time required for the photosensitive drum 1 to rotate through the angle between the contact portion (the brush nip portion), i.e., the contact portion being a portion of contact between the brush member 11 and the photosensitive drum 1, and the developing portion has elapsed, a voltage having the same polarity as the normal polarity of the toner is applied to the transfer roller 5.

In step S6, the control unit 150 determines whether the period T2 corresponding to the distance between the brush portion and the transfer portion has elapsed after the start of rotation of the photosensitive drum 1. The period T2 corresponding to the distance between the brush portion and the transfer portion refers to the time required for a position on the surface of the photosensitive drum 1 located at the brush portion at the start of rotation of the photosensitive drum 1, to reach the transfer portion. If the period T2 corresponding to the distance between the brush portion and the transfer portion has not elapsed (NO in step S6), the control unit 150 returns to step S6. If the period T2 corresponding to the distance between the brush portion and the transfer portion has elapsed (YES in step S6), the control unit 150 executes step S7. In step S7, the control unit 150 determines whether the period T3 corresponding to one full rotation of the transfer roller 5 has elapsed. If the period T3 corresponding to one full rotation of the transfer roller 5 has not elapsed (NO in step S7), the control unit 150 returns to step S7. If the period T3 corresponding to one full rotation of the transfer roller 5 has elapsed (YES in step S7), the control unit 150 executes step S8. In this way, the paper dust F2 is collected by the transfer roller 5 due to the potential difference between the surface potential (0 V) of the photosensitive drum 1 and the transfer voltage (FIG. 9C).

In step S8, the control unit 150 stops the rotation driving of the photosensitive drum 1, turns off the voltages applied to the brush member 11, the charging roller 2, and the developing roller 31, and ends the second activation control. That is, the control unit 150 ends the second activation control when, after the start of rotation of the photosensitive drum 1, a period corresponding to the time required for the photosensitive drum 1 to rotate through the angle between the brush nip portion and the transfer portion has elapsed and then a period corresponding to one full rotation of the transfer roller 5 has further elapsed.

In this way, by performing the second activation control, the paper dust F2 captured by the brush member 11 is collected by the transfer roller 5, and therefore when the first activation control is executed during image formation, the paper dust F2 has already moved from the brush member 11. As a result, image defects caused by paper dust expulsion during image formation can be reduced. If the paper dust F2 remains on the brush member 11 after execution of the second activation control, since the brush voltage (150 V) in the first activation control is smaller than the brush voltage (450 V) in the second activation control, the paper dust is less likely to be expelled.

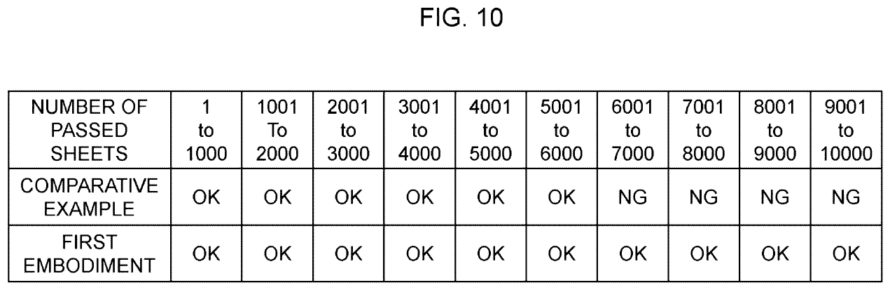

Paper dust expulsion is more likely to occur when activation is repeatedly performed while a certain amount of paper dust has accumulated on the brush member 11 through sheet passage. Therefore, in the first embodiment, when the total number of sheets passed through the image forming apparatus 100 exceeds a prescribed threshold, the second activation control is executed. In the first embodiment, the threshold is set to 5000 sheets. The threshold can be set as appropriate depending on factors such as the usage environment of the image forming apparatus 100 and the characteristics of the recording material P. In addition to the execution determination method based on counting up the total number of sheets passed and comparing the count with a threshold, an execution determination method based on counting down may be used, in which a predetermined value is set as a starting value and the value is decremented for each passed sheet, and the second activation control is executed when the value reaches zero.

<6. Advantageous Effects> A sheet passage test conducted to verify the advantageous effects of the first embodiment will be described. The sheet passage test was performed under the following conditions: a low-temperature and low-humidity environment at 15° C. and 10% relative humidity, using Xerox Vitality Multipurpose paper of Letter size and 75 g/m² basis weight as the recording material P. Two-sheet passage jobs were repeatedly executed until a total of 10,000 sheets was passed. For the image evaluation, black spot images appearing on one recording material P were counted, and when three or more spots of 0.8 mm or greater, which have a significant visual impact, were observed, the image was determined as NG. Otherwise, it was determined as OK. The evaluation results for every 1,000 sheets are shown in FIG. 10. In FIG. 10, if even one NG image was observed among the 1000 sheets, the result was determined as NG.

In the comparative example, an image NG occurred when 6,000 sheets or more was passed. In contrast, in the first embodiment, the occurrence of image NG was suppressed throughout the passage of 10000 sheets. This is because the paper dust that had entered the brush nip portion N was expelled by execution of the second activation control during the post-rotation, and collected by the transfer roller 5, thereby suppressing expulsion of paper dust from the brush member 11 in the first activation control in image formation.

In the first embodiment, the second activation control during the post-rotation is executed after the total number of sheets passed exceeds the threshold (5000 sheets), but it may also be executed during the post-rotation starting from the first passed sheet. In the second activation control, the process of collecting paper dust by the transfer roller 5 may be omitted. In such a case, the paper dust F2 expelled from the brush nip portion N makes one revolution with the photosensitive drum 1 and returns to the brush member 11. The paper dust is then captured at the position of the paper dust F1 on the upstream side of the brush member 11 as shown in FIG. 4A. Accordingly, as compared with the case where the paper dust is located at the position of the paper dust F2 in FIG. 4B, the expulsion of paper dust from the brush member 11 during the first activation control can be further suppressed.

There is a possibility that the paper dust expelled during the second activation control adheres to the charging roller 2. However, in this test, no image issues were observed. This is because the charging roller 2 is stopped after the execution of the second activation control during the post-rotation operation, and is then driven to rotate in the first activation control in the image forming operation, causing paper dust on the charging roller 2 to be shaken off by the change in the rotational speed of the charging roller 2. Some of paper dust may have the same polarity as the toner. When paper dust having the same polarity as the toner is expelled from the brush member 11, the paper dust has the same polarity as the voltage applied to the charging roller 2 during the image forming operation, so that the likelihood that the paper dust will remain adhered to the charging roller 2 during the image forming operation is low, and image defects are less likely to occur.

In the first embodiment illustrated above, the second activation control is executed during the post-rotation, but the second activation control may also be executed when activating the photosensitive drum 1 in cases other than when the photosensitive drum 1 is activated for image forming operation, such as during the pre-multi-rotation. In this way, the expulsion of the paper dust can be reduced under the first activation control.

According to the first embodiment, by executing the second activation control during the post-rotation operation and making the voltage applied to the brush member 11 higher toward the polarity opposite to the toner than during the first activation control, image defects caused by the expulsion of paper dust from the brush member 11 can be suppressed.

### Second Embodiment

Now, a second embodiment will be described. In the second embodiment, the same advantageous effect as in the first embodiment can be achieved without using a large brush voltage by controlling the potential of the photosensitive drum 1 during the second activation control. The basic configuration and operation of the image forming apparatus 100 according to the second embodiment are the same as those of the first embodiment. Elements having the same or corresponding functions or configurations as those in the first embodiment will be designated by the same reference numerals as those in the first embodiment, and detailed description thereof will not be provided.

<1. Brush Paper Dust Expulsion Control> Similarly to the first embodiment, the first activation control is executed during the pre-rotation step before entering the image forming operation, and after the execution of the first activation control, the photosensitive drum 1 enters the image forming step without stopping rotation. Meanwhile, the second activation control is executed during the post-rotation operation, and the rotation driving of the photosensitive drum 1 started by the second activation control is stopped after the completion of the second activation control.

In the second embodiment, the voltages applied to the brush member 11 in the first activation control and in the second activation control are equal and are both 150 V. The second surface potential of the photosensitive drum 1 in the second activation control is higher toward the normal polarity of the toner (negative polarity in the second embodiment) than the first surface potential of the photosensitive drum 1 in the first activation control. Specifically, the first surface potential is 0 V, and the second surface potential is −300 V, which is the same polarity as the normal polarity of the toner. Accordingly, the absolute value of the second potential difference (450 V) between the brush voltage and the surface potential of the photosensitive drum 1 during the second activation control is greater than the absolute value of the first potential difference (150 V) between the brush voltage and the surface potential of the photosensitive drum 1 during the first activation control. This allows paper dust to be expelled from the brush nip portion N during the second activation control and reduces paper dust expulsion during the first activation control.

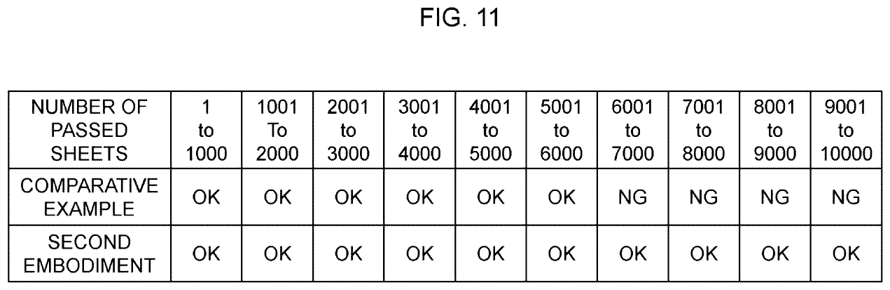

After the second activation control, the voltage of the charging roller 2 is set to 0 V, the voltage of the developing roller 31 is set to 150 V, and paper dust adhesion is suppressed. The voltage of the transfer roller 5 is set to −1000 V, so that the paper dust is collected by the transfer roller 5. Similarly to the first embodiment, the second activation control is executed after a total of 5000 sheets have been passed.

<2. Advantageous Effects> To evaluate the advantageous effects of the second embodiment, a test similar to that in the first embodiment was performed. The evaluation results are shown in FIG. 11. In the comparative example, black spots occurred when 6,000 sheets or more were passed. In contrast, in the second embodiment, the occurrence of the black spots was suppressed throughout the passage of 10000 sheets.

According to the second embodiment, the second activation control is executed during the post-rotation operation, and the potential difference between the brush voltage and the surface potential of the photosensitive drum in the second activation control is set higher toward the polarity opposite to the normal polarity of the toner than in the first activation control, so that image defects caused by the expulsion of paper dust from the brush can be reduced.

In the above-described embodiments, the toner image formed on the photosensitive drum 1 is transferred to the recording material P serving as a transfer target in the transfer portion, but the image forming apparatus to which the present disclosure can be applied is not limited to this configuration. For example, the present disclosure is also applicable to an image forming apparatus in which the toner image is primarily transferred to an intermediate transfer belt as a transfer target in the transfer portion, and secondarily transferred from the intermediate transfer belt to the recording material P. Furthermore, in the above-described embodiments, the image forming apparatus 100 has the photosensitive drum 1, the charging roller 2, and the developing apparatus 3, but the present disclosure is also applicable to an image forming apparatus that operates with a process cartridge system. In this case, a support member 13 that supports the brush member 11 in contact with the photosensitive drum 1 may be provided in a process cartridge having the photosensitive drum 1, and the brush member 11 may be fixed to the process cartridge. In the above-described embodiments, a common power source is used to apply voltages to both the brush member 11 and the developing roller 31, but separate power sources may be provided for applying voltages to these elements. In the above embodiments, the present disclosure is applied to a cleanerless type image forming apparatus. That is, in the image forming apparatus 100, the developing apparatus 3 removes toner, which remains on the surface of the photosensitive drum 1 without being transferred to the recording material, from the surface of the photosensitive drum 1.

The present disclosure serves to suppress image defects in an image forming apparatus including a brush configured to contact with a surface of a photosensitive drum.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. An image forming apparatus comprising:
a photosensitive drum that is rotatable;
a charging unit configured to form a charging portion between the photosensitive drum and the charging unit and charge a surface of the photosensitive drum in the charging portion;
a developing unit configured to contact with the photosensitive drum to form a developing portion and supply, in the developing portion, toner to the surface of the photosensitive drum charged by the charging unit;
a transfer unit configured to contact with the photosensitive drum to form a transfer portion and transfer, in the transfer portion, the toner supplied to the photosensitive drum to a transfer target;
a brush configured to contact with the surface of the photosensitive drum downstream of the transfer portion and upstream of the charging portion in a rotational direction of the photosensitive drum;
an applying unit configured to apply a voltage to the brush;
a drive unit configured to rotate the photosensitive drum; and
a control unit configured to control the applying unit and the drive unit, wherein
the control unit is configured to execute a first activation control and a second activation control,
the first activation control starts the rotation of the photosensitive drum in a state in which a potential difference between the voltage applied to the brush and a potential of the surface of the photosensitive drum is a first potential difference,
the second activation control starts the rotation of the photosensitive drum in a state in which the potential difference between the voltage applied to the brush and the potential of the surface of the photosensitive drum is a second potential difference,
each of the first potential difference and the second potential difference is formed such that an electrostatic force from the brush toward the surface of the photosensitive drum acts on a particle charged to a polarity opposite to a normal polarity of the toner, and
the second potential difference has an absolute value greater than an absolute value of the first potential difference.

2. The image forming apparatus according to claim 1,
wherein
the surface potential of the photosensitive drum in the first activation control and the surface potential of the photosensitive drum in the second activation control are equal to each other,
each of a first brush voltage applied to the brush in the first activation control and a second brush voltage applied to the brush in the second activation control is a voltage having a polarity opposite to the normal polarity of the toner, and
the second brush voltage has an absolute value greater than an absolute value of the first brush voltage.

3. The image forming apparatus according to claim 2, wherein
each of the surface potential of the photosensitive drum in the first activation control and the surface potential of the photosensitive drum in the second activation control is 0 V.

4. The image forming apparatus according to claim 1,
wherein
a voltage applied to the brush in the first activation control and a voltage applied to the brush in the second activation control are equal to each other, and
a second surface potential of the photosensitive drum in the second activation control is higher toward the normal polarity of the toner than a first surface potential of the photosensitive drum in the first activation control.

5. The image forming apparatus according to claim 4,
wherein
the first surface potential is 0 V, and
the second surface potential has the same polarity as the normal polarity of the toner.

6. The image forming apparatus according to claim 1, wherein
the control unit performs an image forming operation without stopping the rotation of the photosensitive drum after executing the first activation control.

7. The image forming apparatus according to claim 1, wherein
the control unit stops the rotation of the photosensitive drum after executing the second activation control.

8. The image forming apparatus according to claim 1, wherein
in the second activation control, the control unit applies a voltage having the same polarity as the normal polarity of the toner to the transfer unit.

9. The image forming apparatus according to claim 1, wherein
in the second activation control, the control unit applies a voltage having the same polarity as the normal polarity of the toner to the transfer unit at a timing at which, after starting the rotation of the photosensitive drum, a time required for a portion of the surface of the photosensitive drum located in a contact portion between the brush and the photosensitive drum to reach the developing portion has elapsed.

10. The image forming apparatus according to claim 9,
wherein
the transfer unit includes a transfer roller that is rotatable; and
in the second activation control, the control unit ends the second activation control at a timing at which, after starting the rotation of the photosensitive drum, a time required for the portion of the surface of the photosensitive drum located in the contact portion to reach the transfer portion has elapsed, and a time corresponding to one rotation of the transfer roller has elapsed after the portion of the surface of the photosensitive drum has reached the transfer portion.

11. The image forming apparatus according to claim 1, wherein
the control unit executes the second activation control in a case that a total number of sheets passed through the image forming apparatus exceeds a predetermined threshold value.

12. The image forming apparatus according to claim 1, wherein
the control unit executes the second activation control in a post-rotation operation performed after an image forming operation.

13. The image forming apparatus according to claim 1, wherein
the control unit executes the first activation control in a case of starting the rotation of the photosensitive drum for an image forming operation, and executes the second activation control in a case of starting the rotation of the photosensitive drum for an operation except for the image forming operation.

14. The image forming apparatus according to claim 1, wherein
the image forming apparatus is a cleanerless type image forming apparatus configured such that toner remaining on the surface of the photosensitive drum without being transferred to the transfer target is removed from the surface of the photosensitive drum by the developing unit.

15. The image forming apparatus according to claim 1, wherein
the applying unit applies a voltage to the brush and the developing unit.
